(19) United States
(12) Patent Application Publication
(10) Pub. No.: US 2022/0019347 A1
(43) Pub. Date: Jan. 20, 2022

(54) Electronic devices with dual display screens

(71) Applicant: Qiusheng Gao, Newark, CA (US)

(72) Inventor: Qiusheng Gao, Newark, CA (US)

(73) Assignee: Qiusheng Gao, Newark, CA (US)

(21) Appl. No.: 16/929,116

(22) Filed: Jul. 15, 2020

(51) Int. Cl. G06F 3/0488; G06F 3/0354; G06F 1/16

(52) U.S. Cl. CPC G06F 3/04886; G06F 3/04883; G06F 3/03545; G06F 2203/04106; G06F 1/1618; G06F 1/1671; G06F 1/1681; G06F 1/1647

(57) ABSTRACT

An electronic device with dual screens has a second touch screen for tablet, e-reader/notepad or smartphone. The original or the second screen of the device can choose either e-ink type display or LED/OLED type of display. The combination of e-ink type display for second screen and non e-ink type display for original screen takes advantage of power saving and high-quality image/wide color range from both type of display technology based on the application. Read only permission for application lunched on second screen simplifies the file management system. A virtual keyboard with virtual mouse pad and handwriting touchpad provides ease of mixed input for formal typing or handwriting characters, drawing and digital signature. A laptop or PC with physical keyboard replaced by a touch screen can work as a laptop/PC plus a tablet interchangeably at the same time with ease of mixed input for typing keys, handwriting, drawing and digital signature. The new devices with dual screen provide users best experience for the scenario reading a book while writing notes with ease of mixed input, store and retrieve information.

### CROSS REFERENCE TO RELATED APPLICATIONS

I hereby claim benefit of U.S. provisional patent application No. 62/888,553 filed on 19 Aug. 2019, 62/889,575 filed on 20 Aug. 2019 and 62/912,978 filed on 9 Oct. 2019. These three applications are currently pending and hereby incorporated by reference into this application.

### TECHNICAL FIELD

The present invention generally relates to the innovative dual display screen with multiple input technology to provide users with better ways for simultaneous reading and writing work, comparing with the existing tablet, e-reader, smartphone, laptop and PC of a single display monitor. Especially with stylus or digital pen for handwriting technology, the new device provides users better experience to write electronic notes instead of paper notes with ease of mixed input for formal words, handwriting, drawings and digital signature. New display technology with e-ink type of screen are more power efficient and glare free that makes the eye more pleasant for reading under bright light. Other non e-ink type of display technology, e.g., LED or OLED, provides high image quality, wide color range and faster refresh rates. Multi-core CPU or GPU technology can improve the device performance for multiple tasks. The new device is going to integrate those new technology together to create a perfect device for persons reading book while writing notes interchangeably at the same time.

### BACKGROUND ART

In schools and offices, most people need to read a book or document while writing notes at the same time. But most existing electronic devices are not able to provide a good user experience for simultaneous reading and writing work. That is why people are still using lots of paper books and notes while we can easily digitalize almost any kind of document.

Currently, most tablets or e-readers or smartphones use one touch screen as display and virtual key boards or pencil as input. Tablet is easy to be used with a finger or a stylus or digital pen as input, but it is not convenient if there are lots of input from the keyboard because the virtual keyboard is small for one hand. Some tablets also have a detachable physical keyboard. When users use the physical keyboard for tablet, users are not easy to handwrite with the stylus or digital pen. Most laptops and PCs have one physical keyboard, one mouse and one display screen for input and display. When users use the physical keyboard that is good for lots of input from keyboard in the laptop or PC, users are not able to handwrite with the stylus or digital pen.

Most tablets and smartphone use the IPS LCD or OLED type of display, which is not glare free under bright light and consumes battery fast. Most e-readers use the e-ink type display that is glare free and consumes power very slowly, but the refresh rate is low. Though e-readers provide users good reading experience like a natural paper book under bright light, most e-readers are for reading with limited ability for input. Most e-readers and smartphones have a small screen to display one application.

While we digitalize most documents, we still write many paper notes because the existing electronic devices have lots of issues. Paper notes are not only wasting lots of paper and store space, but also not convenient for information retrieve.

### SUMMARY OF THE INVENTION

The object of the present invention is to combine the advantage of existing electronic devices including tablet, e-reader, smartphone, laptop and PC with new display and handwriting technology, providing better user experience for simultaneous reading and writing work. Especially with the handwriting technology from the stylus or digital pen, the new device will help users writing electronic notes instead of paper notes. The new device also utilizes the e-ink type of screen to save power consumption and provide better reading experience under bright light. This device will attract people to abandon the paper books and notes, which will save lot of papers for the world.

In accordance with the present invention, the new device has four working mode for tablet, e-reader/notepad and smartphone. First mode is book and note mode that uses two screens, one screen for reading and another screen for reading/writing as e-reader, tablet/notepad and smartphone. Second mode is touch screen mode that uses one screen as an existing regular tablet, e-reader/notepad or smartphone. Third mode is reading mode that uses one screen for reading only. In reading mode, the device can save the power, especially with e-ink type screen. Fourth mode is laptop mode that uses two screens, one screen for display and another screen implemented as a virtual keyboard plus handwriting for input from stylus or digital pen. This mode is similar to a laptop with the physical keyboard being replaced by a virtual keyboard and the additional handwriting input from the screen. The best status for the dual screen device is that a user reads the document from one screen and input the contents from another screen with a stylus or digital pen. Such a situation is very similar to the scenario that people are reading a book while writing notes. It will help people get rid of the paper book and notes.

In accordance with the present invention, the new device has two working mode for laptop and PC. In first mode, the touch screen is implemented as a virtual keyboard with the similar size of regular keyboard. The virtual keyboard has a virtual mouse touchpad and a handwriting pad. Users can input contents with keys and handwriting by stylus or digital pen interchangeably. Virtual keys need less pressing power than the physical. In second mode, the touch screen is used as a tablet. Users can read/write documents through the touch screen and read documents displayed on the regular screen. The tablet mode and laptop/PC mode can run interchangeably with the virtual keyboard being turned on/off.

In accordance with the present invention, the new device does not need much additional hardware components except an additional screen, comparing with a regular tablet/laptop. So, the device will have the similar weight to a tablet. It needs to modify the input/output system with different ports to support two screens for input and display.

In accordance with the present invention, the second screen connects to the tablet, e-reader/notepad or smartphone type of devices with some ports through a cable, or wireless connection without cable. This new device can use different type of port and cable depending on the manufacturers. The second screen can be designed as a separate or detachable piece, or fixed to the device with hinges.

In accordance with the present invention, a virtual keyboard is implemented on the screen of the tablet, e-reader/notepad or smartphone when the new device is working on laptop mode. To prevent using shift key for second characters on some keys, keys on the virtual keyboard are re-arranged that duplicated numeric keys are removed and special characters such as $, # are put together on the area of duplicated numeric keys. The re-arrangement of keys will provide better user experience since user is easier to find a special character in a concentrated area than in a spreading apart area. It needs less pressing power on the virtual keyboard than on the physical keyboard so the virtual keyboard will have less health problem. The virtual keyboard has a virtual mouse touchpad and a handwriting touchpad with stylus or digital pen. The handwriting touchpad has two working mode: catch what is written on the pad or translate what is written to the formal characters or words. Pressing one virtual key will change the touchpad working status between catch mode and translate mode. Pressing another virtual key can choose the language. The big size pad supports multiple lines of input. The virtual handwriting touchpad improve the input methodology over traditional physical keyboard.

In accordance with the present invention, the new device with the tablet, e-reader or notepad or smartphone can use a pair of hinges that allow 360-degree rotation, so the device can be folded up in two ways. When user is not using the device, the device is folded up with the second screen facing the screen of the smartphone. When a user is using only one screen of the device, the device can be folded up with both the second screen and the screen of the tablet, e-reader/notepad or smartphone being outside of the device so the user is easy to hold the device with a single hand.

In accordance with the present invention, the new device with small size display area has three-layer layout from the regular physical keyboard. Comparing with the existing standard virtual keyboard with small size, the numeric keys and arithmetic operator keys are put together on one virtual keyboard to improve the user experience for math related work. Pressing a virtual key will switch to the virtual keyboard for English alphabet characters. Pressing another virtual key will switch to the virtual keyboard for special characters. Two arrow keys are added to the virtual keyboard so users can move the cursor easily in case with many characters in a short text box.

In accordance with the present invention, the display on two screens can be processed by separate core of multi-core CPU/GPU. Comparing with the single screen device, the new device will not overload the system with multi-core CPU/GPU since I/O system is relatively slow. For small screen devices such as e-readers and smartphones, two screens can display two tasks while one screen can display one task at one time only.

In accordance with the present invention, the new device can store and retrieve all electronic document, e.g., e-books, digital notes and drawings in local device storage or from remote cloud.

### BRIEF DESCRIPTION OF THE DRAWINGS

FIG. 1 provides the primary vertical view from the top when the device with dual screens is put on the desk. The second screen connects the tablet or e-reader/notepad through a cable or wireless connection, but the second screen and the tablet or e-reader/notepad are designed as separate pieces.

FIG. 2 provides the primary vertical view from the top when the device with dual screens is put on a desk. The second screen is connected with the tablet or e-reader/notepad through a pair of hinges.

FIG. 3 provides the 3-D view of the device when the second screen is put flat on a desk and the tablet or e-reader/notepad is standing with an obtuse angle with the second screen. The device works as a laptop while the second screen is implemented as a virtual keyboard with regular key size similar to the key size in the regular physical keyboard.

FIG. 4 provides the primary vertical view of a virtual mouse touchpad from the top when the device is put on a desk.

FIG. 5 provides first layout for a virtual keyboard with regular key size similar to the key size in the regular physical keyboard. To prevent using the shift key for some special characters, the virtual keyboard moves those special characters to the area of duplicated numeric keys. The virtual keyboard does not use duplicated numeric keys anymore. The virtual keyboard has a virtual mouse touchpad.

FIG. 6 provides second layout for a virtual keyboard with regular key size similar to the key size in the regular physical keyboard. To prevent using the shift key for some special characters, the virtual keyboard moves those special characters to the area of duplicated numeric keys. The virtual keyboard does not use duplicated numeric keys anymore. The virtual keyboard has a virtual mouse touchpad and a small size handwriting pad for stylus and digital pen. The handwriting touchpad has two working mode: catch what is written on the pad or translate what is written to the formal characters or words. Pressing the key with word “mod” will change the touchpad working status between catch mode and translate mode. Pressing the key with word “lang” can choose the language.

FIG. 7 provides second layout for a virtual keyboard with regular key size similar to the key size in the regular physical keyboard. To prevent using the shift key for some special characters, the virtual keyboard moves those special characters to the area of duplicated numeric keys. The virtual keyboard does not use duplicated numeric keys anymore. The virtual keyboard has a virtual mouse touchpad and a big size handwriting pad for stylus and digital pen. The handwriting pad has two working mode: catch what is written on the pad or translate what is written to the formal characters or words. Pressing the key with word “mod” will change the touchpad working status between catch mode and translate mode. Pressing the key with word “lang” can choose the language.

FIG. 8 provides the primary vertical view of a new device from the top when the device is put on the desk. The device has a smartphone and a second screen connected through a pair of hinges.

FIG. 9 provides the 3-D view of a new device that is put on the desk. The device has a smartphone and a second screen connected through a pair of hinges. The second screen is standing with an obtuse angle with the smartphone.

FIG. 10 provides second layer layout for a virtual keyboard with small key size implemented on the full screen of said smartphone or partial screen of said tablet or e-reader/notepad. The virtual keyboard has three virtual keyboards. Comparing with the existing popular virtual keyboard on smartphone, this layout put the numeric keys and arithmetic operator keys together on the second layer layout to improve the user experience. Pressing the ABC key will switch to the first layer virtual keyboard for English alphabet. Pressing $#& key will switch to the third layer virtual keyboard for special characters. Two arrow keys are added to the virtual keyboard so users can move the cursor easily.

FIG. 11 provides side view of the device from the bottom when the device is folded up with said second screen facing the screen of said smartphone.

FIG. 12 provides side view of the device from the bottom when the device is folded up with both said second screen and the screen of said smartphone at outside of the device. The device needs a pair of hinges or soft cover that allows 360-degree rotation. It depends on the manufacturer choosing the type of hinge.

FIG. 13 provides the primary vertical view from the top when a stylus or digital pen is put on a desk.

FIG. 14 provides the 3-D view of a laptop with the physical keyboard replaced by a touch screen.

FIG. 15 provides the 3-F view of a PC, monitor and a touch screen.

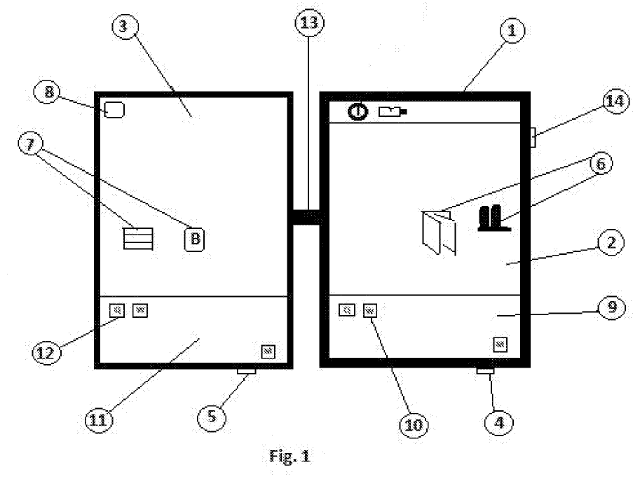

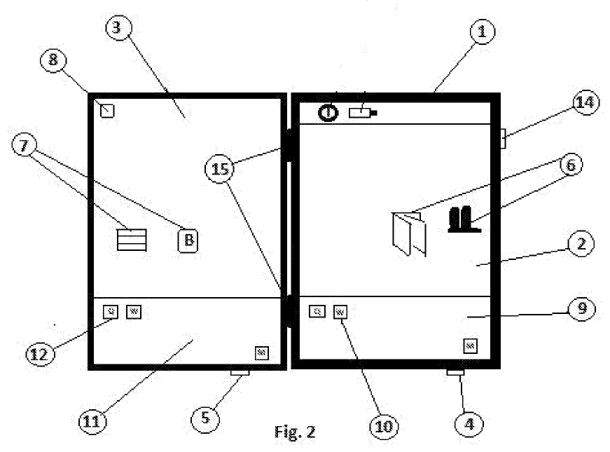

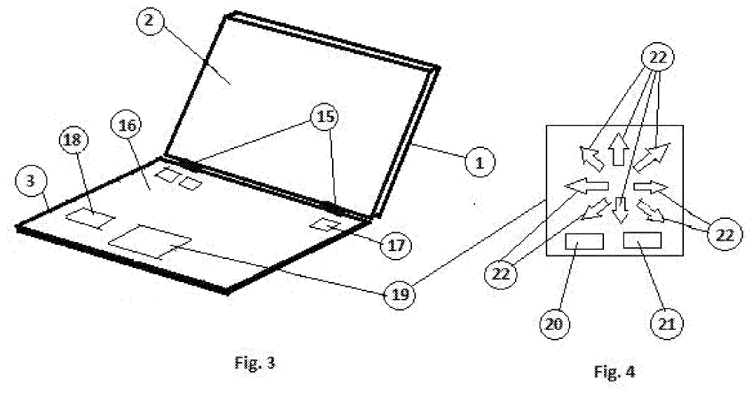

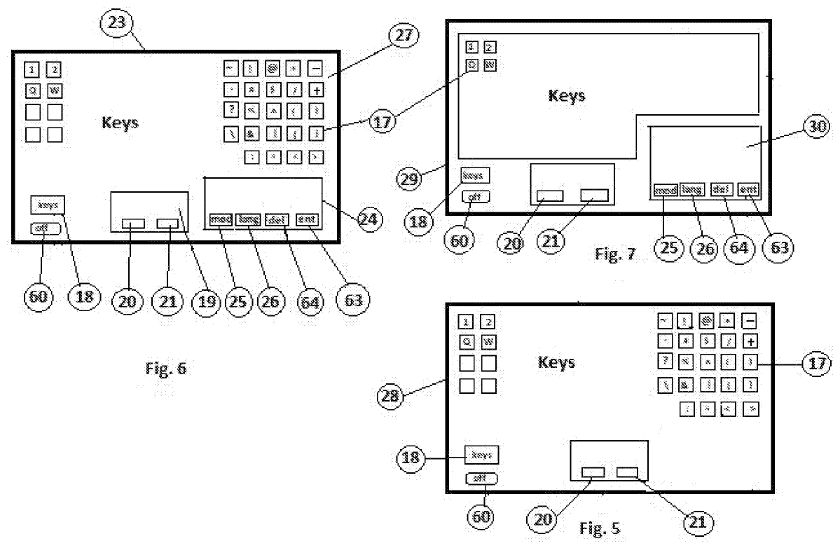

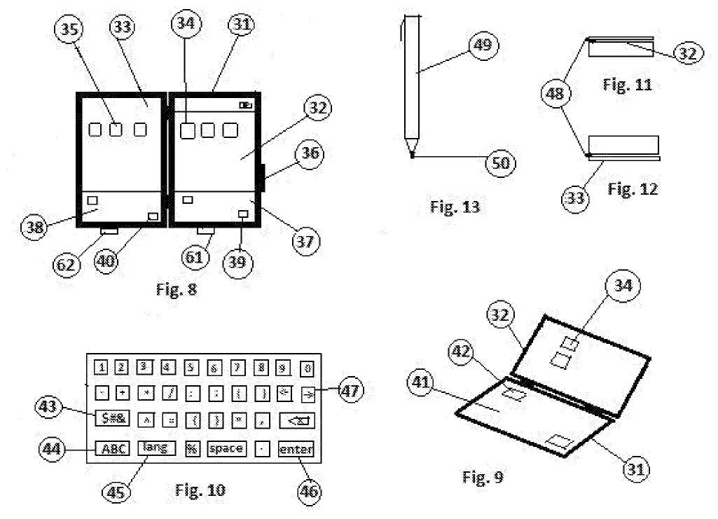

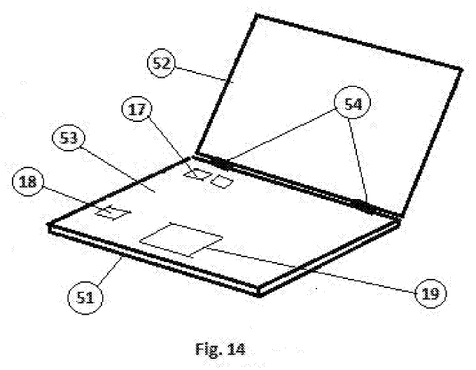

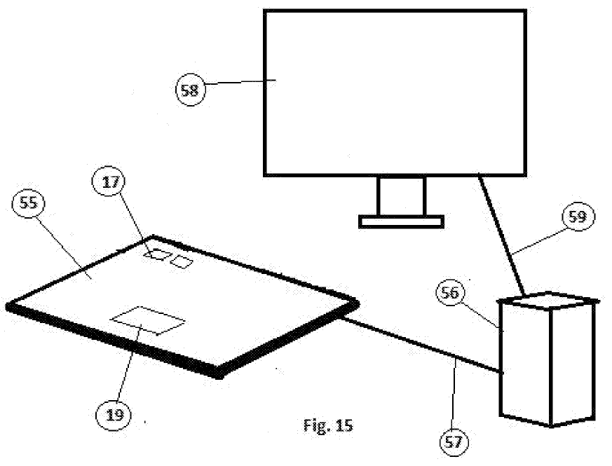

Following are the detailed information about the primary components of the device.
1. A tablet or e-reader/notepad. It has a port for a cable that connects a second touch screen.
2. A touch screen on said tablet or e-reader/notepad. The touch screen supports the input from finger touch or stylus or digital pen. The touch screen can be implemented as a virtual keyboard on part or full.
3. A second screen that supports finger touch. The second screen is connected with said tablet or e-reader/notepad through a cable or wireless connection. Support for stylus or digital pen is optional for this screen. The touch screen can be implemented as a virtual keyboard on part or full.
4. A push button that can turn on/off the screen on said tablet or e-reader/notepad.
5. A push button that can turn on/off said second screen.
6. Control icons for files that are displayed on said tablet or e-reader/notepad. Taping on the icon will display the files under the icon or run the application under this icon.
7. Control icons for files that are displayed on said second screen. Taping on the icon will display the files under the icon or run the application under this icon.
8. Control icons for the full screen virtual keyboard. Touching this icon will lunch the full screen virtual keyboard.
9. A virtual keyboard with small size implemented on the screen of said tablet or e-reader/notepad. The drawing does not show all virtual keys in the virtual keyboard.
10. A virtual key on said virtual keyboard on the screen of said tablet or e-reader/notepad.
11. A virtual keyboard with small size implemented on said second screen. The drawing does not show all virtual keys in the virtual keyboard.
12. A virtual key on said virtual keyboard on said second screen.
13. A cable that connects said tablet or e-reader/notepad with said second screen. There is different type of cables. There is no specific requirement for cable type. The manufacturer can choose the type of cable based on design.
14. A push button that can change the device working status between touch screen mode and laptop mode. Pressing this button will turn on/off the full screen virtual keyboard on said second screen of the device.
15. A pair of hinges that connects said tablet or e-reader/notepad with said second screen.
16. A virtual keyboard with same key size of regular physical keyboard, implemented on the screen of said tablet or e-reader/notepad. The drawing does not show all keys in the virtual keyboard. Instead, the word “keys” are used to represent the keys not drawn.
17. A virtual key on said virtual keyboard.
18. A special key that can change the layout of said virtual keyboard. If this key is pressed, the virtual keyboard will switch to another layout that has an additional handwriting pad.
19. A virtual mouse touchpad on said virtual keyboard, which can control the cursor on said original screen of said tablet, e-reader or notepad.
20. A virtual left click button on said virtual mouse touchpad.
21. A virtual right click button on said virtual mouse touchpad.
22. The direction of the finger move/swipe on said virtual mouse touchpad.
23. The layout of a virtual keyboard with a virtual mouse touchpad and a small size virtual handwriting pad for input from stylus and digital pen. To prevent using shift key for the second character on the keys, keys on the virtual keyboard are re-arranged that the duplicated numeric keys are removed and those special characters are put together on the area of duplicated numeric keys. If the size of screen is small, traditional layout with shift key will be kept.
24. A small size virtual handwriting touchpad that supports stylus and digital pen. This pad has two working mode: catch mode that catches what is written on the pad, or translate mode that translates what is written to formal characters or words. The small size virtual handwriting touchpad supports single line of input.
25. A virtual key with word “mod” that controls working status of said virtual handwriting touchpad. Pressing this key will change the pad working status between catch mode and translate mode.
26. A virtual key with word “lang” that controls the language for said virtual handwriting touchpad.
27. The area where special characters are put together. It would be more convenient for users looking up the special key.
28. The layout of a virtual keyboard with a virtual mouse touchpad. To prevent using shift key for the second character on the keys, keys on the virtual keyboard are re-arranged that the duplicated numeric keys are removed and those special characters are put together on the area of duplicated numeric keys. If the size of screen is small, traditional layout with shift key will be kept.
29. The layout of a virtual keyboard with a virtual mouse touchpad and a big size virtual handwriting pad for input from stylus and digital pen. To prevent using shift key for the second character on the keys, keys on the virtual keyboard are re-arranged that the duplicated numeric keys are removed and those special characters are put together on the area of duplicated numeric keys. If the size of screen is small, traditional layout with shift key will be kept.
30. A big size virtual handwriting pad for input from stylus and digital pen. This pad has two working mode: catch mode that catches what is written on the pad, or translate mode that translates what is written to formal characters or words. The big size virtual handwriting touchpad supports multiple lines of input.
31. A smartphone.
32. A touch screen on said smartphone.
33. A second screen for said smartphone.
34. Application icons on the screen of said smartphone.
35. Application icons on said second screen of smartphone.
36. A push button that can turn on/off the full screen virtual keyboard on second screen of said smartphone.
37. A small size virtual keyboard on the screen of said smartphone. This keyboard has three-layer layouts. Comparing with the existing popular virtual keyboard on smartphone, the numeric keys and arithmetic operator keys are put together on second layer layout shown in FIG. 10.
38. A small size virtual keyboard on the screen of said smartphone. This keyboard has three-layer layouts. Comparing with the existing popular virtual keyboard on smartphone, the numeric keys and arithmetic operator keys are put together on second layer layout shown in FIG. 10.
39. A virtual key on said small size virtual keyboard on said smartphone. Not all keys are drawn on the small size virtual keyboard.
40. A key on said small size virtual keyboard on said second screen. Not all keys are drawn on the small size virtual keyboard.
41. A virtual keyboard with small size implemented on full screen of said smartphone. This keyboard has three-layer layouts. Comparing with the existing popular virtual keyboard on smartphone, the numeric keys and arithmetic operator keys are put together on second layer layout shown in FIG. 10.
42. A virtual key on said virtual keyboard with small size.
43. A virtual key with word “$#&” for switching to another layout of the virtual keyboard for some special characters after said key being pressed.
44. A virtual key with word “ABC” for switching to another layer layout of the virtual keyboard for English alphabet after said key being pressed.
45. A virtual key with word “lang” for setting language.
46. A virtual key for enter.
47. An arrow key that allows moving the cursor.
48. A hinge that allows 360-degree rotation.
49. A stylus or digital pen.
50. The penpoint of said stylus or digital pen.
51. A laptop with the physical keyboard replaced by a touch screen.
52. The regular screen on said laptop.
53. A touch screen that replaces the physical keyboard on said laptop. This screen can be implemented as a virtual keyboard with different layouts.
54. A pair of hinges that connects said laptop with the regular screen.
55. A touch screen that is connected to a PC through a cable.
56. A PC, i.e., a personal computer.
57. A cable that connects said touch screen with said PC.
58. A monitor that is connected to said PC.
59. A cable that connects said monitor with said PC.
60. A virtual key that controls the virtual keyboard. Press this virtual key will turn off the virtual keyboard.
61. A push button that will turn on/off the screen on said smartphone.
62. A push button that will turn on/off said second screen for said smartphone.
63. A virtual key with word “ent” on the virtual handwriting touchpad. Pressing this key will complete the handwriting on the virtual handwriting touchpad and the written contents will be displayed on the open document.
64. A virtual key with word “del” on said virtual handwriting touchpad with either bigger or small size. Pressing this virtual key will allow user clearing the written contents on the handwriting touchpad.

### DETAILED DESCRIPTION OF PREFERRED EMBODIMENTS

When the new device with a tablet or e-reader/notepad (1) and a second touch screen (3) is powered on, the device is working on book and notes mode with both original screen (2) on said tablet, e-reader/notepad and said second screen (3) on. In this mode, users can read document on the second screen (3) while read/write document on the original screen (2) by handwriting with a stylus/digital pen (49) or typing virtual keys (10) on a virtual keyboard (9). The document or application is lunched by pressing the file icons (6) (7) on the original screen (2) or the second screen (3). All application lunched on the second screen (3) only have reading permission that does not allow to change the contents of the files. Reading only permission will simplify the file managing system without cache coherent issue. The device also allows copying the contents displayed on the second screen (3) to the document displayed on the original screen (2). Following is a good example of a student using this device in a classroom.

When a student opens an e-book by pressing at a file icon (7) on the second screen (3), he presses another icon (6) on the original screen (2) to lunch an e-note. When the student is reading the e-book displayed on the second screen (7), he can use the finger swipe to flip the book pages. At the same time, the student can write notes with a stylus or digital pen (49) or typing keys (10) on the virtual keyboard (9). If the student wants to search something through the internet, he can close the e-book and lunch the web browser by pressing the file icon (7). Then the student finds the contents through the internet, he highlights the contents on the web browser through the finger touch. After a task bar pops up, the student presses the copy item then moves the cursor to the original screen (2) by pressing the place on the notes on the original screen (2). After another task bar pops up, the student presses the paste item and the contents are copied to the e-notes. If the student needs something in other notes but these notes are stored in the cloud, the student can download the notes or read the notes online through a wireless connection. The student can quickly find the contents on the notes through keyword search. After class is done, the student saves the written notes to the local storage or cloud storage. Look at the whole period in the class, this device provides students much better ways to read, write and retrieve information than the traditional heavy paper book and notes in the classroom.

After the student finishes his class, he is going to read a novel on the train. To save the battery, he turns off the original screen (2) and reads the novel on the second screen (3) only. The device is working in reading mode. If the second screen (3) is made of e-ink type of display, it can save power consumption and provide better reading experience under bright light. The student has to hold the device for reading in the train without a desk, so he folds up the second screen to outside of the device with a pair of hinges (15) that allows 360-degree rotation. If the second screen (3) is designed as a separate piece, a leather or plastic cover can hold the second screen (3) and the tablet or e-reader/notepad together with 360-degree rotation.

After the student is back home, he is going to draw a few pictures. The student does not need the second screen (3) anymore and turn off the second screen (3) with push button (5). The device is working on touch screen mode as a pure tablet or e-reader/notepad (1). The student uses a stylus (49) drawing a picture on the original screen (2) of the tablet (1).

After the student finishes the drawing, he needs to write a text document with formal format. The students turned on both original screen (2) and second screen (3). Then he pushes the button (14) and a full screen virtual keyboard (16) appears on the second screen (3). The push button (14) can also be replaced by a software implemented icon (8) on the second screen (3). The device is working on laptop mode that supports lots of input from keys. The student can type keys (17) and handwrite on a virtual handwriting touchpad (24) interchangeably. After he finishes the document, he signs his signature at the end. The student can save the document either in local device or remote cloud storage.

The regular size virtual keyboard (16) has three layouts. The first layout is same as the regular physical keyboard while the mouse touchpad is implemented as a virtual mouse pad (19). The second layout is same as the regular physical keyboard with a virtual mouse pad (19) plus a virtual small size handwriting touchpad (24) for stylus and digital pen (49). The small size virtual handwriting touchpad (24) only supports single line of input. It has two working mode. In first mode, the touchpad (24) catches what is written or drawn and the contents are displayed on the file on the original screen after the virtual key with word “ent” (63) is pressed. In second mode, the touchpad (24) translates what is written to formal characters or words. The translation is especially helpful for non-English language. The third layout is same as the regular physical keyboard with a virtual mouse pad (19) plus a big size handwriting touchpad (30) for stylus and digital pen (49). This touchpad (30) supports multiple lines of input at one time. There is re-arrangement of keys that duplicated numeric keys are removed. If the size of the second screen (3) is big enough, the shift key is removed and those special characters are put together in the area (27) of duplicated numeric keys.

If the device is a smartphone (31) with a second touch screen (33), it has the same type of operation in four working mode described above. The difference is that the full screen virtual keyboard (41) implemented on the second screen (33) has three-layer layouts due to the small size of the screen. In this device, the second layer layout shown as FIG. 10 is re-arranged that the numeric keys are put together with the arithmetic operator to make math related work more convenient. A pair of arrow keys are added to each layer of layouts to move the cursor more conveniently with long text in short text box. Another difference is that the battery life is very important for smartphone, so the second screen with e-ink display will help the smartphone battery lasting much longer.

If the device is a laptop (51), the physical keyboard is replaced with a touch screen (53). The device has two working mode: tablet mode or laptop mode. In tablet mode, users can open the file by pressing the file icon on the touch screen (53) for reading, drawing and writing through finger touch, stylus or digital pen. In laptop mode, the touch screen (53) is implemented as a regular size virtual keyboard (16) that has three layouts as described above. Users can lunch the application displayed on the original laptop screen (52) using the virtual mouse touchpad (19) or a regular physical mouse pad. Users can type the virtual keys (17) for input and use the stylus or digital pen for input.

If the device is a PC (56), the physical keyboard is replaced with a touch screen (55). The touch screen (55) is connected with the PC (56) by a cable (57) or wireless connection. The device has two working mode: tablet mode or PC mode. In tablet mode, users can open the file by pressing the file icon on the touch screen (55) for reading, drawing and writing through finger touch, stylus or digital pen. In PC mode, the touch screen (55) is implemented as a virtual keyboard (16) that has three layouts as described above. Users can lunch the application displayed on the original PC screen (58) using the virtual mouse touchpad (19) or a regular physical mouse pad. Users can type the virtual keys (17) for input and use the stylus or digital pen for input.

For the device with laptop and PC, the tablet mode and the laptop/PC mode can work interchangeably. Multiple applications can run on tablet mode and laptop/PC mode at the same time. Turning on/off the virtual keyboard (16) will switch the device between tablet mode and laptop/PC mode. It will be more convenient for a person who can read multiple documents on laptop or PC screen while write notes on the touch screen with ease of mixed input by typing keys or handwriting with a stylus or digital pen.

This device with dual screens needs some modification in operating system, I/O, and related software and hardware. But there is not much additional hardware cost except the touch screen since I/O is relatively slow so an additional touch screen will not overload the system with multi-core CPU/GPU. There is no difference for setting up WiFi device, camera and other hardware/software between single and dual screen device.

The touchable screens (1) (3) or (31) (33) support hand gesture such as swipe left, right, shrink, expand, etc. The image or text displayed on the e-ink type screen (2) or (32) is converted to black and white if the second screen (2) or (32) is a black white screen. The device should support word, pdf, text file, jpg, png and other type of image files. The device should support multiple fonts for different language.

### Variations of the Innovation

There are many types of variation of this innovation. Here are a few examples.

With the new technology, non e-ink type display screen also has the advantage of glare free. This new device can use the new type of display technology.

The new device also can use the foldable display screen to replace two separate screens. The above two screens can be implemented by software as two display zone.

1. An electronic device with dual screens (2) (3) or (32)(33), comprising:
a tablet or c-reader or notepad (1) with a touch screen (2) or a smartphone (31) with a touch screen (32), both screens (2) or (32) support both finger touch and stylus or digital pen;
a second touch screen (3) or (33) of said tablet or e-reader or notepad (1) or said smartphone (31);
a cable (13) or wireless connection between said second screen (3) and said tablet or e-reader or notepad (1), or another cable or wireless connection between said second screen (33) and said smartphone (31); and
a push button (4) that can turn on/off the screen (2) on said tablet or e-reader or notepad (1), or a push button (61) that can turn on/off the screen (32) on said smartphone (31);
a push button (5) that can turn on/off said second screen (3), or a push button (62) that can turn on/off said second screen (33).

2. The electronic device with dual screens of claim 1, wherein said second screen (3) or (33) can display documents for reading only and the original screen (2) or (32) can display documents for reading and writing at the same time when both said screens are turned on.

3. The electronic device with dual screens of claim 2, wherein said second screen (3) or (33) displaying documents for reading only simplify the file management system of said device without cache coherent issue.

4. The electronic device with dual screens of claim 2, wherein said original screen (2) or (32) can be used to input contents by typing virtual keys (10) or (39) on a virtual keyboard (9) or (37) and handwriting with a stylus or digital pen (49).

5. The electronic device with dual screens of claim 2, wherein contents displayed on said second screen (3) or (33) can be copied and pasted in the documents displayed on the original screen (2) or (32).

6. The electronic device with dual screens of claim 2, wherein said push buttons (4) (5) or (61) (62) can turn off one or both of said screens (2) (3) or (32) (33) to save power consumption.

7. The electronic device with dual screens of claim 2, wherein said second screen (3) or (33) and said tablet or e-reader or notepad (1) or said smartphone (31) connected by a pair of hinges or soft leather cover allowing 360-degree rotation that allows said second screen (3) or (33) can be folded up outside of the device provides convenience for users holding the device while using one screen of the device.

8. The electronic device with dual screens of claim 1, wherein said second screen (3) or (33) made of e-ink type of display and the original screen (2) or (32) of said tablet or e-reader or notepad (1) or smartphone (31) made of non e-ink type display can take both advantage of lower power consumption and glare free under bright light of e-ink type display and bright image quality/wide range of colors of LEDs or other non e-ink type display depending on the application.

9. The electronic device with dual screens of claim 8, wherein the non e-ink screen (2) or (32) being turned off will make the battery life of the device much longer.

10. A virtual handwriting touchpad, comprising a rectangle touch area with four virtual keys:
(1). Virtual key with word “mod” for changing working mode of said touchpad: catch what is written or translate written contents to formal characters or words;
(2). Virtual key with word “lang” for changing language;
(3). Virtual key with word “del” for clearing said touchpad;
(4). Virtual key with word “ent” for completing the handwriting and displaying the written contents on the open document.

11. A virtual handwriting touchpad of claim 10, wherein said touchpad with small size rectangle (24) supports single line of input and large size rectangle (30) supports multiple lines of input.

12. A regular size virtual keyboard, comprising:
keys arranged as traditional MS or MAC or other standard keyboards; or
keys arranged with duplicated numeric keys removed and special characters put together in the duplicated numeric area (27) for easy lookup and convenient typing without shift key if the display size is big enough;
a virtual mouse touchpad (19);
a virtual handwriting touchpad of claim 11.
a virtual key with word “keys” (18) for changing layout of said regular size virtual keyboard between layout (23), (28) and (29);
a virtual key with word “off” (60) for turning off and icon (8) for turning on said virtual keyboard (16) by software implementation; or
a push button (14) for turning on/off said virtual keyboard (16) by hardware solution.

13. A small size virtual keyboard, comprising:
three-layer layouts:
(1). One layer for English alphabet;
(2). One layer for numeric keys and arithmetic operator that is convenient for math related work, comparing the existing standard smartphone virtual keyboard;
(3). One layer for other characters;
(4). Two arrow keys for moving cursor conveniently with long text in a short text box.

14. The electronic device with dual screens of claim 1, wherein a regular size virtual keyboard of claim 12 implemented on said second screen (3) of said tablet or e-reader or notepad (1) can be used as the input using both virtual keys and stylus or digital pen for application lunched on the original screen (2) with ease of mixed input for formal words, handwriting, drawings and digital signature.

15. The electronic device with dual screens of claim 1, wherein a small size virtual keyboard of claim 13 implemented on said second screen (33) of said smartphone (31) can be used as the input using both virtual keys and stylus or digital pen for application lunched on the original screen (32) with ease of mixed input for formal words, handwriting, drawings and digital signature.

16. A laptop or PC with dual screens, comprising:
a laptop (51) or PC (56);
the regular screen (52) of laptop (51) or monitor (58) of PC (56);
a touch screen (53) replacing the physical keyboard of laptop; or
a touch screen (55) connected with a PC (56) by a cable (57) or wireless connection.

17. A laptop or PC with dual screens of claim 15, wherein a regular size virtual keyboard of claim 12 can be used as the input by both typing keys and handwriting with stylus and digital pen for application lunched on the regular monitor (52) of laptop or (58) of PC with ease of mixed input for formal words, handwriting, drawings and digital signature.

18. A laptop or PC with dual screens of claim 16, wherein application lunched on said touch screen (53) of laptop or (55) of PC with input from said touch screen (53) or (55) using stylus or digital pen or typing keys on small size virtual keyboard of claim 13 with ease of mixed input for formal words, handwriting, drawings and digital signature when said virtual keyboard of claim 12 being turned off can run at the same time with the application lunched on the regular monitor (52) or (58).

19. The electronic device with dual screens of claim 1 or 2 or 3 or 4 or 5 or 6 or 7 or 8 or 9 or 14 or 15 or 16 or 17 or 18 provides better user experience for a user reading an e-book while writing e-notes interchangeably with more efficient and convenient ways to store and retrieve information with e-notes saved either in local device or remote cloud storage.

20. The electronic device with dual screens of claim 1 or 2 or 3 or 4 or 5 or 6 or 7 or 8 or 9 or 14 or 15 or 16 or 17 or 18, wherein multi-core CPU/GPU can improve the performance of the device with separate core of CPU/GPU processes the tasks displayed on each screen.
